(19) United States
(12) Patent Application Publication
(10) Pub. No.: US 2017/0185142 A1
(43) Pub. Date: Jun. 29, 2017

(54) METHOD, SYSTEM AND SMART GLOVE FOR OBTAINING IMMERSION IN VIRTUAL REALITY SYSTEM

(71) Applicants: Le Holdings (Beijing) Co., Ltd., Beijing (CN); LE SHI ZHI XIN ELECTRONIC TECHNOLOGY (TIANJIN) LIMITED, Tianjin (CN)

(72) Inventor: Chao Zhang, Tianjin (CN)

(21) Appl. No.: 15/249,530

(22) Filed: Aug. 29, 2016

Related U.S. Application Data
(63) Continuation of application No. PCT/CN2016/088679, filed on Jul. 5, 2016.

(30) Foreign Application Priority Data
Dec. 25, 2015 (CN) 201510995889.6

(51) Int. Cl. G06F 3/01; G06T 19/00

(52) U.S. Cl. CPC G06F 3/011; G06T 19/006; G06F 3/014

(57) ABSTRACT

Disclosed are a method, system and smart glove for obtaining immersion in a virtual reality system. The method includes: when an image capturing device captures a case where a finger of a user makes a gesture, a virtual reality client obtains the gesture of the finger and determines whether a target preset gesture identical to the gesture of the finger exists or not, and if yes, sends touch sensation demand information corresponding to the target preset gesture and identification information of the finger to a smart hand wearable device; and the smart hand wearable device converts the received touch sensation demand information into a response action and makes it act on the corresponding finger, such that the finger produces a sensation corresponding to the response action.

### CROSS REFERENCE TO RELATED APPLICATIONS

This application is a continuation application of International Application No. PCT/CN2016/088679 filed on Jul. 5, 2016, which claims priority to Chinese Patent Application No. 201510995889.6, titled “METHOD, SYSTEM AND SMART GLOVE FOR OBTAINING IMMERSION IN VIRTUAL REALITY SYSTEM”, filed before Chinese Intellectual Property Office on Dec. 25, 2015, the entire contents of which are incorporated herein by reference.

### TECHNICAL FIELD

The disclosure belongs to the field of a virtual reality technology, and particularly relates to a method, system and smart glove for obtaining immersion in a virtual reality system.

### BACKGROUND

The inventor has found in the process of performing the present invention that a virtual reality (VR) technology produces a realistic virtual environment integrating visual, audio and touch within a specific range by using a computer or other smart computing device as a core and combining a photoelectric sensing technology in a process of realizing the disclosure. A VR system mainly includes an input device and an output device. A head mount display (HMD) is a virtual reality display output device shaped like a pair of spectacles, which receives an instruction by sensing eye movements of a person, presents an image, and may directly display various kinds of data on the spectacles to be provided to a user. An interaction between the output device and its corresponding input device can make the user produce an independently closed immersive interaction experience.

In the prior art, the VR system may realize gesture interaction based on a 2D or 3D camera. However, the VR system may generally display the acquired image on the HMD in real time to provide the user with the immersion, without a touch sensation. If the immersion is poor, the attraction of the product to the user is reduced.

### SUMMARY

The disclosure provides a method, system and smart glove for obtaining immersion in a virtual reality system, which make sensation information act on a hand of a human body by a smart hand wearable device to increase a touch sensation of a user, thereby improving a motion sensing interaction immersion of the user and enhancing the attraction of a product.

The embodiments of the present disclosure provide a method for obtaining immersion in a virtual reality system, including:

when an image capturing device captures a case where a finger of a user makes a gesture, a virtual reality client obtains the gesture of the finger;

the virtual reality client determines whether a target preset gesture identical to the gesture of the finger exists or not;

if the target preset gesture exists, the virtual reality client sends touch sensation demand information corresponding to the target preset gesture and identification information of the finger to a smart hand wearable device; and

the smart hand wearable device converts the received touch sensation demand information into a response action and makes the response action act on the finger corresponding to the identification information, such that the finger produces a touch sensation corresponding to the response action.

The embodiments of the present disclosure further provide a system for obtaining immersion in a virtual reality system, including:

a mobile terminal and a smart hand wearable device;

wherein an image capturing device and a virtual reality client are provided in the mobile terminal;

the mobile terminal is configured to, when the image capturing device captures a case where a finger of a user makes a gesture, obtain the gesture of the finger by the virtual reality client, and determine whether a target preset gesture identical to the gesture of the finger exists or not by the virtual reality client,

if the target preset gesture exists, send touch sensation demand information corresponding to the target preset gesture and identification information of the finger to a smart hand wearable device; and

the smart hand wearable device is configured to convert the received touch sensation demand information into a response action, and make the response action act on the finger corresponding to the identification information, such that the finger produces a touch sensation corresponding to the response action.

The disclosure provides a smart glove, which is configured to implement the above method for obtaining immersion in a virtual reality system, and includes:

an information receiving apparatus and a response action generating apparatus;

the information receiving apparatus is configured to receive the touch sensation demand information and the identification information of the finger, which are sent by the virtual reality client; and

the response action generating apparatus is configured to convert the received touch sensation demand information into a response action, and make the response action act on the finger corresponding to the identification information, such that the finger produces a touch sensation corresponding to the response action.

It may be known from the above embodiments of the disclosure that, according to the disclosure, an image capturing device captures an image of a finger movement of a user, a virtual reality client determines, according to the image, a gesture made by the finger, and sends touch sensation demand information corresponding to the gesture to a smart hand wearable device; the smart hand wearable device converts the touch sensation demand information into a response action, and makes the response action act on the finger, such that the finger produces a corresponding sensation to increase a touch sensation in body sensations of the user, thereby improving a motion sensing interaction immersion of the user and enhancing the attraction of a product.

### BRIEF DESCRIPTION OF THE DRAWINGS

To more clearly describe the technical solution in the embodiments of the disclosure or in the prior art, the following will briefly introduce the accompanying drawings to be used in the description of the embodiments or the prior art. It is apparent to those skilled in the art that, the accompanying drawings in the following description are merely illustrative of some embodiments of the disclosure; and other accompanying drawings may be obtained according to these accompanying drawings without paying inventive efforts.

FIG. 1 is a block diagram of a structure of a mobile terminal.

FIG. 2 is a schematic diagram of a structure of a system for obtaining immersion in a virtual reality system according to a first embodiment of the disclosure.

FIG. 3 is a schematic diagram of an implementation process of a method for obtaining immersion in a virtual reality system according to a second embodiment of the disclosure.

FIG. 4 is a schematic diagram of an implementation process of a method for obtaining immersion in a virtual reality system according to a third embodiment of the disclosure.

FIG. 5 is a schematic diagram of a structure of a smart glove according to a fourth embodiment of the disclosure.

### DETAILED DESCRIPTION

To make the objects, features and advantages of the disclosure be more obvious and easy to understand, a technical solution will be completely and clearly described below in conjunction with the accompanying drawings in the embodiments of the disclosure. It is apparent that the embodiments described are merely illustrative of some, but not all embodiments of the disclosure. Based on the embodiments in the disclosure, all other embodiments obtained by those skilled in the art without paying inventive efforts all belong to a protective scope of the disclosure.

The present disclosure provides a method and a system for obtaining immersion in a virtual reality system, wherein the touch sensation information is acted on the hand of a human body by the smart hand wearable device to increase touch sensation of a user, thereby improving motion sensing interaction immersion of the user, and enhancing the attraction of a product.

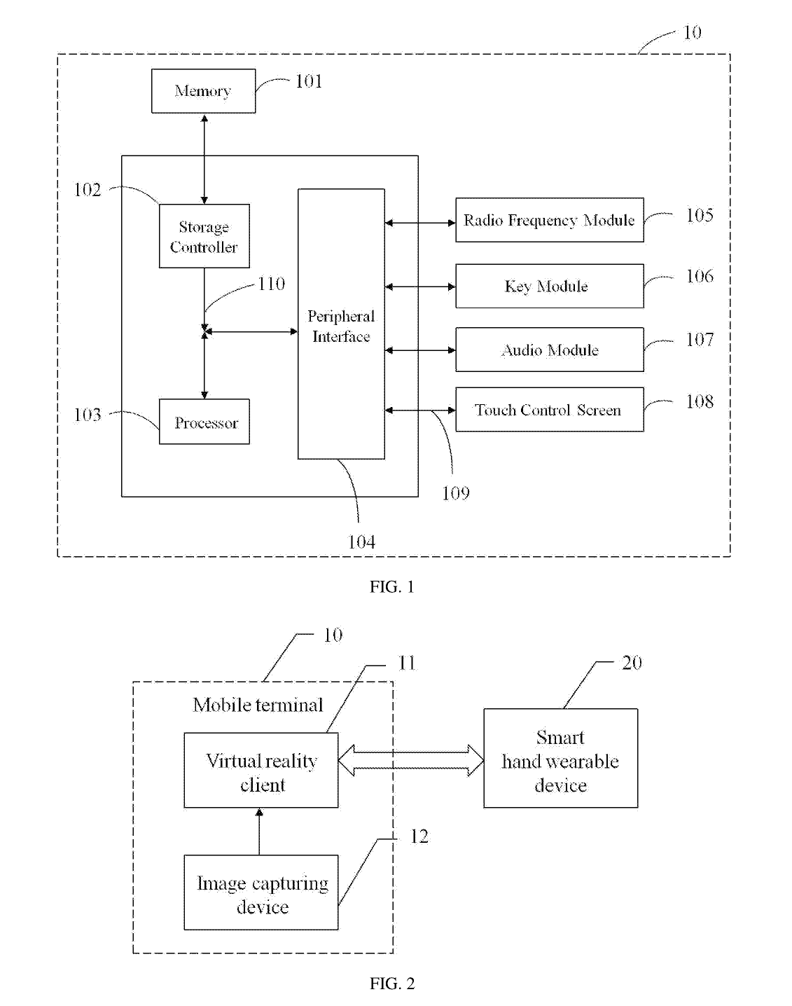

FIG. 1 shows a block diagram of a structure of a mobile terminal. A method for obtaining immersion in a virtual reality system, which is provided by an embodiment of the disclosure, may be applied to a mobile terminal 10 as shown in FIG. 1, and the mobile terminal 10 may include, but is not limited to, a smart phone, a notebook computer, a tablet personal computer, and the like.

As shown in FIG. 1, the mobile terminal 10 includes a memory 101, a storage controller 102, one or more (only one shown in the figure) processors 103, a peripheral interface 104, a radio frequency module 105, a key module 106, an audio module 107 and a touch screen 108. These components are mutually communicated by one or more communication buses/signal lines 109.

It can be understood that a structure shown in FIG. 1 is merely schematic, but is not intended to limit the structure of the mobile terminal. The mobile terminal 10 may further include more or less components than those shown in FIG. 1, or has a configuration different from that shown in FIG. 1. The components as shown in FIG. 1 may be realized by employing hardware, software or a combination thereof.

The memory 101 may be configured to store soft programs and modules, such as program instructions/modules corresponding to a method for obtaining immersion in a virtual reality system in the embodiment of the disclosure. The processor 103 executes various functional applications and data processing by running the software programs and the modules which are stored in the memory 101, that is, the method for obtaining immersion by the above mobile terminal 10 in the virtual reality system is realized.

The memory 101 may include a high-speed random access memory, and may further include a nonvolatile memory, such as one or more magnetic storage mobile terminal, a flash memory, or other nonvolatile solid-state memories. In some embodiments, the memory 101 may further comprise memories remotely disposed relative to the processor 103, and these remotely disposed memories may be connected to the mobile terminal 10 through a network. Instances of the above network include, but are not limited to, Internet, Intranet, a local area network, a mobile communication network and a combination thereof. Access of the processor 103 and other possible components to the memory 101 may be performed under the control of the storage controller 102.

The peripheral interface 104 couples various input/output apparatuses to a CPU and the memory 101. The processor 103 runs various kinds of software and instructions in the memory 101 to execute various functions of the mobile terminal 10 as well as perform data processing.

In some embodiments, the peripheral interface 104, the processor 103 and the storage controller 102 may be implemented in a single chip. In other embodiments, they may be implemented respectively by individual chips.

The ratio frequency module 105 is configured to receive and send electromagnetic waves to realize mutual conversion of the electromagnetic waves and an electrical signal, thereby being communicated with a communication network or other devices. The radio frequency module 105 may include various existing circuit elements configured to execute these functions, for example, an antenna, a radio frequency transceiver, a digital signal processor, an encryption/decryption chip, a subscriber identity module (SIM) card, a memory and the like. The radio frequency module 105 may be communicated with various networks, such as Internet, Intranet and a preset type wireless network or communicated with other devices through a preset type wireless network. The above preset type wireless network may include a cellular telephone network, a wireless local area network and a metropolitan area network. The above preset type wireless network may use various communication standards, protocols and technologies, including, but not limited to, a Global System for Mobile Communication, (GSM), an Enhanced Data GSM Environment (EDGE), a Wideband Code Division Multiple Access (W-CDMA), a Code Division Multiple Access (CDMA), a Time Division Multiple Access (TDMA), a Bluetooth, a Wireless-Fidelity (WiFi) (such as IEEE 802.11a, IEEE 802.11b, IEEE802.11g and/or IEEE 802.11n), a Voice over Internet Protocol (VoIP), a Worldwide Interoperability for Microwave Access (Wi-Max), other protocols for mails, instant messaging and short message services, as well as any other suitable communication protocols.

The key module 106 provides a user with an interface for performing input on a mobile terminal, and the user may press different keys to enable the mobile terminal 10 to execute different functions.

The audio module 107 provides an audio interface to the user, which may include one or more microphones, one or more speakers and an audio circuit. The audio circuit receives sound data from the peripheral interface 104, converts the sound data into electrical information, and transmits the electrical information to the speaker. The speaker converts the electrical information into a sound wave hearable by a human ear. The audio circuit receives the electrical information from the microphone, converts an electrical signal into sound data, and transmits the sound data to the peripheral interface 104 for being further processed. The audio data may be acquired from the memory 101 or by the radio frequency module 105. In addition, the audio data may also be stored in the memory 101 or be sent by the radio frequency module 105. In some embodiments, the audio module 107 may further include an earphone playing hole, which is configured to provide an audio interface to an earphone or other devices.

A touch screen 108 provides an output and input interface between the mobile terminal and the user. Particularly, the touch screen 108 displays audio output to the user, and contents output by these videos may include texts, graphics, videos and any combination thereof. Some output results correspond to some user interface objects. The touch screen 108 also receives an input of the user, for example, gesture operations such as clicking and sliding of the user, so that the user interface object makes a response for these inputs of the user. A technology of detecting the input of the user may be based on a resistance type touch detection technology, a capacitance type touch detection technology or any other possible touch detection technology. A particular instance of a display unit of the touch screen 108 includes, but is not limited to, a liquid crystal display or a light-emitting polymer display.

With reference to FIG. 2, FIG. 2 is a schematic diagram of a structure of a system for obtaining immersion in a virtual reality system according to a first embodiment of the disclosure. The system includes:

a mobile terminal 10 and a smart hand wearable device 20 connected with the mobile terminal 10 by means of a wireless manner. An image capturing device 11 and a virtual reality client 12 are provided in the mobile terminal 10.

In particular, the virtual reality client 11 is installed and operated in the mobile terminal 10, and the virtual reality client 11 may be a VR app (application), and performs data interaction with the smart hand wearable device 20.

The image capturing device 12 may be a camera of the mobile terminal 10, and may also be an image capturing device which is singly mounted independent from other devices. Exemplified in FIG. 2 is the camera of the mobile terminal 10 as the image capturing device.

The smart hand wearable device may be a smart glove, a smart bracelet, or other smart wearable device capable of enabling a hand of a human body to produce a touch sensation.

The wireless connection manner includes WIFI, Bluetooth, infrared and other connection manners.

The mobile terminal 10 is configured to, when the image capturing device 11 captures a case where a finger of a user makes a gesture, particularly, when the image capturing device captures an image that the finger of the user moves, obtain the gesture of the finger by the virtual reality client 12, wherein the image may be multiple continuous static picture images, and may also be a dynamic video image.

The virtual reality client may obtain the gesture of the finger from the image. The case may be that one hand or two hands make the gesture, and the smart hand wearable device is worn on the hand making the gesture, and may be the smart glove, and may also be the smart bracelet. In contrast, since one smart glove may control sensations of five fingers, it may generate more complex touch sensation than the smart bracelet. The smart glove is provided with a response action generating apparatus with a relatively complex function. However, the smart bracelet is worn on the wrist, and may achieve a function similar to that of the smart glove by configuring auxiliary response action generating apparatuses. The auxiliary response action generating apparatuses may be electronic rings which may be sleeved on individual fingers, these electronic rings are connected with the smart bracelet by means of a wireless or wired manner, and the smart bracelet may execute response actions through the electronic rings, and embody the response actions to the individual fingers.

The mobile terminal 10 determines whether a target preset gesture identical to the gesture of the finger exists or not by the virtual reality client 12, the mobile terminal is locally provided with a gesture database in which information of a plurality of gestures is stored, and the information may be information such as an image, a video and the like of the gesture. If the target preset gesture exists, touch sensation demand information corresponding to the target preset gesture and identification information of the finger are sent to the smart hand wearable device 20.

Particularly, the mobile terminal 10 is further configured to inquire, by the virtual reality client 11, the images of the plurality of preset gestures stored in the gesture database, and compare the image of the gesture of the finger with the images of the plurality of preset gestures. Multiple continuous static picture images of the gesture of the finger may be respectively compared with multiple continuous static picture images of the plurality of preset gestures, or a dynamic video image of the gesture of the finger may be respectively compared with dynamic video images of the plurality of preset gestures.

Further, whether a target preset gesture a matching degree of which is within a preset range with the gesture of the finger exists in the plurality of preset gestures or not is determined. The matching degree refers to a similarity degree. If the matching degree of the two gestures is within the preset range, it indicates that the similarity degree of the two gestures is relatively high, and the two gestures may be considered to be two same gestures. Whether one gesture or more gestures exist in the plurality of preset gestures or not is determined, the matching degree with the gesture of the finger is within the preset range, and if such one or more gestures exist, it or they are confirmed to be the target preset gesture. Setting the range of the matching degree may improve the flexibility of determining the gesture of the finger.

Further, the mobile terminal 10 is further configured to, if the plurality of the target preset gestures exist, obtain a virtual picture viewed by the user when making the gesture of the finger; determine a virtual object pointed by the gesture of the finger in the virtual picture; and by combining a physical property of the virtual object and the gesture of the finger, determine the touch sensation demand information corresponding to the target preset gesture, and send the touch sensation demand information and the identification information of the finger to the smart hand wearable device 20.

Particularly, relatively simple preset gestures and touch sensation demand information may be stored in the gesture database, the preset gestures may only include gestures with obvious features and relatively simple constitutions, and its corresponding touch sensation demand information is simple as well, for example, a gesture of “squeezing the hand into a fist to beat forwardly”, its corresponding touch sensation demand information is relatively simple as well, only with a vibratory sensation of the whole hand.

In a case where such preset gestures are relatively simple, one target preset gesture matched with the gesture of the finger may be determined from the plurality of preset gestures through the above simple comparison. If the target preset gesture exists, the touch sensation demand information corresponding to the target preset gesture is found, and the found touch sensation demand information and the identification information of the finger are sent to the smart hand wearable device together, such that the smart hand wearable device may know which finger corresponds to the touch sensation demand information.

In further aspect, relatively complex preset gestures and touch sensation demand information may also be stored in the gesture database, that is, a plurality of preset gestures which are slightly different may be stored in the gesture database, each preset gesture corresponds to more pieces of touch sensation demand information, and the touch sensation demand information is not only related to the preset gesture, and also related to a virtual object touched by the finger. For example, a plurality of “finger clicking” gestures exist in the gesture database, the touch sensation demand information corresponding to each “finger clicking” gesture is different, some only have a simple vibratory sensation and sharp sensation, and some may produce a hot or cold touch sensation produced due to different virtual objects touched.

When the plurality of target preset gestures exist, the touch sensation demand information corresponding to the gesture of the finger may not be determined according to a unique target preset gesture, but may be determined further. Particularly, it may be implemented by means of the following manner of acquiring a virtual picture viewed by the user when making the gesture of the finger, and the virtual picture is viewed by the user through a HMD in the VR system or other spectacles devices with a function of displaying the virtual picture. Further, a human body image of the user is captured by the image capturing device, a height of the finger of the user relative to a human body is confirmed, the virtual object pointed by the gesture of the finger in the virtual picture may be determined in combination with the virtual picture, or a focus position of an eye when the user makes the gesture of the finger is obtained, and the virtual object pointed by the gesture of the finger in the virtual picture may also be determined. For example, by means of the previously described manner, it may be determined that when the user makes a gesture that five fingers touch, the virtual object pointed by the gesture in the virtual picture simultaneously viewed by the user is an ice sculpture.

Determining the touch sensation demand information corresponding to the target preset gesture is determined in combination with the physical property of the virtual object and the gesture of the finger may improve the accuracy of determining the touch sensation demand information, and the touch sensation demand information and the identification information of the finger are sent to the smart hand wearable device. For example, the ice sculpture has a cold physical property, the user touches the ice sculpture with the five fingers, it may be determined that the five fingers of the user are to be cooled. In this way, information of requiring cooling the five fingers and identification information of the five fingers are sent to the smart hand wearable device.

The mobile terminal 10 is further configured to send a correspondence between the touch sensation demand information and the identification information corresponding to the finger to the smart hand wearable device 20 by means of a wireless propagation manner.

The wireless propagation manner may be WIFI, Bluetooth, infrared, near field communication and the like.

The smart hand wearable device 20 is configured to convert the received touch sensation demand information into a response action, and make the response action act on the finger corresponding to the identification information, such that the finger produces a touch sensation corresponding to the response action.

The response action includes one or more actions of vibrating, tightening, heating and cooling, and acts on the finger corresponding to the identification information.

For example, the smart glove receives the touch sensation demand information, wherein the touch sensation demand information refers to sensation that the finger is to be tightened; converts the touch sensation demand information into a corresponding response action, that is, tightening; and tightens the finger corresponding to the identification information, such that the finger produces a tightening sensation.

According to the method for obtaining immersion in the virtual reality system provided by this embodiment, an image capturing device captures an image that a finger of a user moves, a virtual reality client determines, according to the image, a gesture made by the finger, and sends touch sensation demand information corresponding to the gesture to a smart hand wearable device; the smart hand wearable device converts the touch sensation demand information into a response action, and makes the response action act on the finger, such that the finger produces a corresponding sensation so as to increase a touch sensation in body sensations of the user, thereby improving a motion sensing interaction immersion of the user and enhancing the attraction of a product.

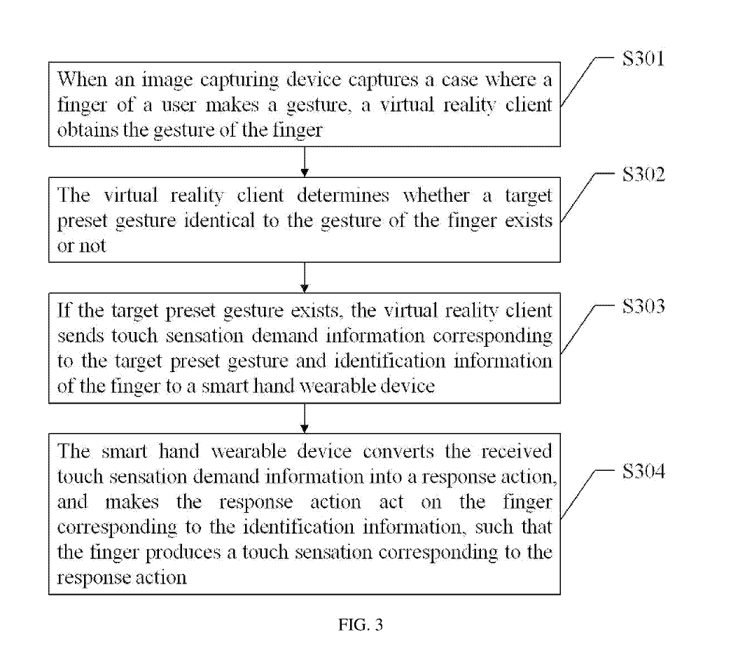

With reference to FIG. 3, FIG. 3 is a schematic diagram of an implementation process of a method for obtaining immersion in a virtual reality system according to a second embodiment of the disclosure. The method for obtaining immersion in a virtual reality system, which is provided by this embodiment, mainly includes the following steps:

S301: When an image capturing device captures a case where a finger of a user makes a gesture, a virtual reality client obtains the gesture of the finger.

The image capturing device may be a camera in a mobile terminal, and may be an image capturing device which is singly mounted independent from other devices such as a mobile terminal. The image capturing device transmits the captured image to the virtual reality client for being processed. When the image capturing device captures a case where the finger of the user makes the gesture, the virtual reality client obtains the gesture of the finger, particularly, when the image capturing device captures an image that the finger of the user moves, the virtual reality client may obtain the gesture of the finger from the image. The image may be multiple continuous static picture images, and may also be a dynamic video image.

The case may be that one hand or two hands make the gesture, and the smart hand wearable device is worn on the hand making the gesture, and may be a smart glove, and may also be a smart bracelet. In contrast, since one smart glove may control sensations of five fingers, it may generate more complex touch sensation than the smart bracelet. The smart glove is provided with a response action generating apparatus with a relatively complex function. However, the smart bracelet is worn on the wrist, and may achieve a function similar to that of the smart glove by configuring auxiliary response action generating apparatuses. The auxiliary response action generating apparatuses may be electronic rings which may be sleeved on individual fingers, these electronic rings are connected with the smart bracelet by means of a wireless or wired manner, and the smart bracelet may execute response actions through the electronic rings.

S302: The virtual reality client determines whether a target preset gesture identical to the gesture of the finger exists or not.

The mobile terminal is locally provided with a gesture database in which information of a plurality of gestures is stored, and the information may be information such as an image, a video and the like of the gesture.

The virtual reality client may determine whether a target preset gesture identical to that the gesture of the finger exists in the gesture database or not according to the gesture of the finger.

S303: If the target preset gesture exists, the virtual reality client sends touch sensation demand information corresponding to the target preset gesture and identification information of the finger to a smart hand wearable device.

It is to be noted that the mobile terminal is connected with the smart hand wearable device in a wireless connection manner and performs data transmission, particularly performs data exchange with the smart hand wearable device through the virtual reality client operated in the mobile terminal.

If the target preset gesture identical to the gesture of the finger exists, the touch sensation demand information corresponding to the target preset gesture is found, and the touch sensation demand information is configured to represent a type of a touch sensation possibly obtained when the user makes the target preset gesture. For example, the touch sensation demand information means that a vibration is needed.

Further, the found touch sensation demand information and identification information of the finger are sent together to the smart hand wearable device, such that the smart hand wearable device may know which finger corresponds to the touch sensation demand information, wherein the touch sensation demand information may correspond to one finger, or multiple fingers, or even the whole hand. The identification information of the finger is of uniqueness, which is used for identifying an identity attribute of the finger, for example, the identification information may be a unique number of the finger.

S304: The smart hand wearable device converts the received touch sensation demand information into a response action and makes the response action act on the finger corresponding to the identification information, such that the finger produces a touch sensation corresponding to the response action.

For example, the smart glove receives the touch sensation demand information, wherein the touch sensation demand information means that the finger needs to vibrate; converts it into a corresponding response action, that is, vibration; and makes the vibration act on the finger corresponding to the identification information, wherein the identification information may correspond to one finger or also multiple fingers, such that the finger produces a vibration sensation.

According to the method for obtaining immersion in the virtual reality system provided by this embodiment, an image capturing device captures an image of a finger movement of a user, a virtual reality client determines, according to the image, a gesture made by the finger, and sends touch sensation demand information corresponding to the gesture to a smart hand wearable device; the smart hand wearable device converts the touch sensation demand information into a response action, and makes the response action act on the finger, such that the finger produces a corresponding sensation to increase a touch sensation in body sensations of the user, thereby improving a motion sensing interaction immersion of the user and enhancing the attraction of a product.

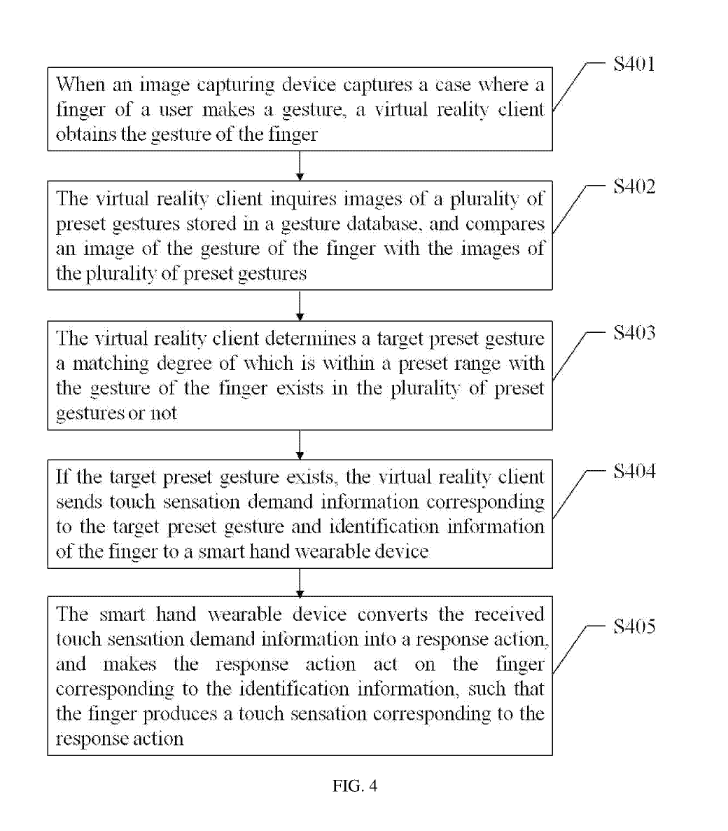

With reference to FIG. 4, FIG. 4 is a schematic diagram of an implementation process of a method for obtaining immersion in a virtual reality system according to a third embodiment of the disclosure. The method for obtaining immersion in a virtual reality system according to this embodiment mainly includes the following steps:

S401: When an image capturing device captures a case where a finger of a user makes a gesture, a virtual reality client obtains the gesture of the finger.

The image capturing device transmits the captured image to a virtual reality client for being processed. When the image capturing device captures a case where the finger of the user makes the gesture, the virtual reality client obtains the gesture of the finger. Particularly, when the image capturing device captures the image that the user makes the gesture, the virtual reality client may obtain the gesture of the finger from the image. The image may be multiple continuous static picture images, and may also be a dynamic video image. The number of the fingers is not limited, and the gesture may be the gesture made by one finger, or may also be a gesture made by multiple fingers together. For example, one finger clicks, or five fingers are squeezed into a fist to beat.

S402: The virtual reality client inquires images of a plurality of preset gestures stored in a gesture database, and compares an image of the gesture of the finger with the images of the plurality of preset images.

Images of a plurality of preset gestures may be stored in a gesture database, and the image of each preset gesture may be multiple continuous static picture images, and may also be a dynamic video image.

The image of the gesture of the finger is compared with the images of the plurality of preset gestures, for example, multiple continuous static picture images of the gesture of the finger are respectively compared with multiple continuous static picture images of the plurality of preset gestures, or the dynamic video image of the gesture of the finger is respectively compared with dynamic video images of the plurality of preset gestures.

S403: The virtual reality client determines whether a target preset gesture a matching degree of which is within a preset range with the gesture of the finger exists in the plurality of preset gestures or not.

The matching degree refers to a similarity degree. If the matching degree of the two gestures is within a preset range, it indicates that the similarity degree of the two gestures is relatively high, and the two gestures may be considered to be two same gestures.

Determine whether one or more gestures having a matching degree with the gesture of the finger within the preset range exist in the plurality of preset gestures or not, and, if the one or more gestures exist, such one or more gestures are the target preset gesture. To confirm that whether the gestures are matched, a range of the matching degree is set, and thus the flexibility of determining the gesture of the finger may be improved.

S404: If the target preset gesture exists, the virtual reality client sends touch sensation demand information corresponding to the target preset gesture and identification information of the finger to the smart hand wearable device.

It is to be noted that, relatively simple preset gestures and touch sensation demand information may be stored in the gesture database, the preset gestures may only include gestures with obvious features and relatively simple constitutions, and its corresponding touch sensation demand information is simple as well, for example, a gesture of “squeezing the hand into a fist to beat forwardly”, its corresponding touch sensation demand information is relatively simple as well, only with a vibratory sensation of the whole hand, for another example, a gesture of “twisting a door lock”, its corresponding touch sensation demand information may be a vibratory sensation of the whole hand as well, only that the vibratory sensation is weaker than that of the above beat.

In a case where such preset gestures are relatively simple, one target preset gesture may be determined from the plurality of preset gestures through the above steps S403 to S404. If the target preset gesture exists, the touch sensation demand information corresponding to the target preset gesture is found, and the found touch sensation demand information and the identification information of the finger are sent together to the smart hand wearable device, such that the smart hand wearable device may know which finger corresponds to the touch sensation demand information.

In contrast, relatively complex preset gestures and touch sensation demand information may also be stored in the gesture database, that is, a plurality of preset gestures which are slightly different may be stored in the database, each preset gesture corresponds to more pieces of touch sensation demand information, and the touch sensation demand information is not only related to the preset gesture, but also related to a virtual object touched by the finger. For example, a plurality of “finger clicking” gestures exist in the gesture database, the touch sensation demand information corresponding to each “finger clicking” gesture is different, some only have a simple vibratory sensation and sharp sensation, and some may produce a hot or cold touch sensation produced due to different virtual objects touched.

When the plurality of target preset gestures exist, the touch sensation demand information corresponding to the gesture of the finger may not be determined according to a unique target preset gesture, but may be determined further. Particularly, a virtual picture viewed by the user when making the gesture of the fingers is acquired, and the virtual picture is viewed by the user through a HMD in the VR system or other spectacles devices with a function of displaying the virtual picture. Further, a human body image of the user is captured by the image capturing device, a height of the finger of the user relative to a human body is confirmed, the virtual object pointed by the gesture of the finger in the virtual picture may be determined in combination with the virtual picture, or a focus position of an eye when the user makes the gesture of the finger is obtained, and the virtual object pointed by the gesture of the finger in the virtual picture may also be determined. For example, by means of the previously described manner, it may be determined that when the user makes a gesture that five fingers splay, the virtual object pointed by the gesture in the virtual picture simultaneously viewed by the user is a fireplace.

Determining the touch sensation demand information corresponding to the target preset gesture in combination with the physical property of the virtual object and the gesture of the finger may improve the accuracy of determining the touch sensation demand information, and the touch sensation demand information and the identification information of the finger are sent to the smart hand wearable device. For example, the fireplace has a physical property of heating, it is determined that that the five fingers of the user are to be heated when splaying. In this way, information of requiring heating the five fingers and identification information of the five fingers are sent to the smart hand wearable device.

S405: The smart hand wearable device converts the received touch sensation demand information into a response action and makes the response action act on the finger corresponding to the identification information, such that the finger produces a touch sensation corresponding to the response action.

The smart hand wearable device converts the received touch sensation demand information into the response action, wherein the response action includes one or more actions of vibrating, tightening, heating and cooling; and making the converted response action act on the finger corresponding to the identification information includes: making one or more actions of vibrating, tightening, heating and cooling act on the finger corresponding to the identification information.

For example, the smart glove receives the touch sensation demand information, wherein the touch sensation demand information refers to sensation that the finger are to be tightened; converts the touch sensation demand information into a corresponding response action, that is, tightening; and tightens the finger corresponding to the identification information, such that the finger produces a tightening sensation.

Other details in this embodiment refer to the description of the previous embodiments shown in FIG. 2 to FIG. 4.

According to the method for obtaining immersion in the virtual reality system provided by this embodiment, an image capturing device captures an image of a finger movement of a user, a virtual reality client determines, according to the image, a gesture made by the finger, and sends touch sensation demand information corresponding to the gesture to a smart hand wearable device; the smart hand wearable device converts the touch sensation demand information into a response action, and makes the response action act on the finger, such that the finger produces a corresponding sensation to increase a touch sensation in body sensations of the user, thereby improving a motion sensing interaction immersion of the user and enhancing the attraction of a product.

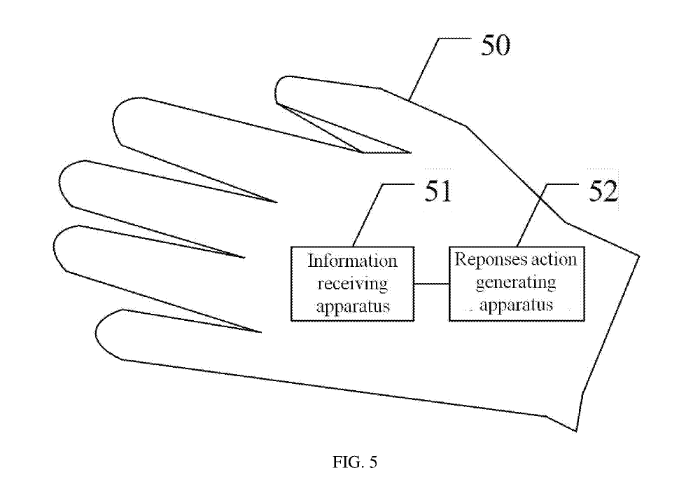

With reference to FIG. 5, FIG. 5 is a schematic diagram of a structure of a smart glove according to a fourth embodiment of the disclosure. For easy of description, it only shows parts related to the embodiment of the disclosure. The smart glove exemplified in FIG. 5 is used for implementing a method for obtaining immersion in a virtual reality system, which is provided by the previous embodiments shown in FIG. 3 to FIG. 4, which particularly refers to the description of the previous embodiments shown in FIG. 2 to FIG. 4 and will be omitted hereinafter. The smart glove 50 exemplified in FIG. 5 is applied to a VR system, and connected with other related devices in the VR system by means of a wireless manner and performs data exchange, for example, the smart glove 50 is connected with the mobile terminal through WIFI.

The smart glove 50 may include an information receiving apparatus 51 and a response action generating apparatus 52.

In particular, the information receiving apparatus 51 is configured to receive the touch sensation demand information and the identification information of the finger, which are sent by the virtual reality client; and the response action generating apparatus 52 is configured to convert the received touch sensation demand information into a response action, and make the response action act on the finger corresponding to the identification information, such that the finger produces a touch sensation corresponding to the response action.

In the individual embodiments of the disclosure, the apparatuses may be integrated into one processing apparatus, or the individual apparatuses may also be physically exist alone, or two or more of the above apparatuses may be integrated into one apparatus. The above integrated apparatus may be implemented in the form of hardware, or may be implemented in the form of a software functional apparatus.

The integrated apparatus may be stored in one computer readable storage medium if being implemented in the form of the software functional apparatus and sold or used as an independent product. Based on such an understanding, a technical solution of the disclosure essentially or a part, making a contribution to the prior art, of the technical solution, or all or some of the technical solution may be embodied in the form of a software product. The computer software product is stored in one storage medium, including a plurality of instructions, which are used for enabling one computer device (which may be a personal computer, a server, a network device and the like) to execute all or some steps of the method of the individual embodiments of the disclosure. The previous storage medium includes various mediums capable of storing program codes, such as a U disk, a mobile hard disk drive, a read-only memory (ROM), a random access memory (RAM), a magnetic disk or a compact disk.

It is to be noted that, while, for purposes of simplicity of explanation, the previous method embodiments are shown and described as a series of act combinations, it is to be understood and appreciated by those skilled in the art that the disclosure is not limited by the described order of acts, as some acts may occur in different orders and/or concurrently in accordance with the disclosure. Next, it is also to be understood and appreciated by those skilled in the art that the embodiments described in the specification all belong to preferred embodiments, and the involved acts, devices and apparatuses are not necessarily required by the disclosure.

In the above embodiments, the individual embodiments are laid particular emphasis respectively, and a part which is not described in detail in a certain embodiment may refer to related description of other embodiments.

Finally, it should be noted that: the above embodiments are merely provided for describing the technical solutions of the present disclosure, but not intended to limit thereto; although the present disclosure has been described in detail with reference to the foregoing embodiments, those skilled in the art will appreciate that: they can make modifications to the technical solutions described in the foregoing embodiments, or make equivalent replacements to some technical features thereof; and these modifications or replacements do not make the essence of corresponding technical solutions depart from the spirit and scope of the technical solution of each embodiment.

What is claimed is:

1. A method for obtaining immersion in a virtual reality system, comprising:
when an image capturing device captures a case where a finger of a user makes a gesture, obtaining the gesture of the finger by a virtual reality client;
determining, by the virtual reality client, whether a target preset gesture identical to the gesture of the finger exists or not;
if the target preset gesture exists, sending touch sensation demand information corresponding to the target preset gesture and identification information of the finger to a smart hand wearable device; and
converting, by the smart hand wearable device, the received touch sensation demand information into a response action and making the response action act on the finger corresponding to the identification information such that the finger produces a touch sensation corresponding to the response action.

2. The method according to claim 1, wherein the response action comprises one or more actions of vibrating, tightening, heating and cooling, and the making the response action act on the finger corresponding to the identification information comprises:
making one or more actions of vibrating, tightening, heating and cooling act on the finger corresponding to the identification information.

3. The method according to claim 1, wherein the determining, by the virtual reality client, whether a target preset gesture identical to the gesture of the finger exists or not comprises:
inquiring, by the virtual reality client, images of a plurality of preset gestures stored in a gesture database, and comparing an image of the gesture of the finger with the images of the plurality of preset images; and
determining whether a target preset gesture having a matching degree with the gesture of the finger within a preset range exists in the plurality of preset gestures or not.

4. The method according to claim 3, wherein the if the target preset gesture exists, sending touch sensation demand information corresponding to the target preset gesture and identification information of the finger to a smart hand wearable device comprises:
if a plurality of the target preset gestures exist, obtaining a virtual picture viewed by the user when making the gesture of the finger;
determining a virtual object pointed by the gesture of the finger in the virtual picture; and
by combining a physical property of the virtual object and the gesture of the finger, determining the touch sensation demand information corresponding to the target preset gesture, and sending the touch sensation demand information and the identification information of the finger to the smart hand wearable device.

5. The method according to claim 1, wherein the sending a correspondence between the touch sensation demand information and the identification information corresponding to the gesture to the smart hand wearable device comprises:
sending a correspondence between the touch sensation demand information and the identification information corresponding to the gesture to the smart hand wearable device by means of a wireless propagation manner.

6. A system for obtaining immersion in a virtual reality system, comprising:
a mobile terminal and a smart hand wearable device;
wherein an image capturing device and a virtual reality client are provided in the mobile terminal;
the mobile terminal is configured to, when the image capturing device captures a case that a finger of a user makes a gesture, obtain the gesture of the finger by the virtual reality client, and determine whether a target preset gesture identical to the gesture of the finger exists or not by the virtual reality client, if the target preset gesture exists, send touch sensation demand information corresponding to the target preset gesture and identification information of the finger to the smart hand wearable device; and
the smart hand wearable device is configured to convert the received touch sensation demand information into a response action, and make the response action act on the finger corresponding to the identification information such that the finger produces a touch sensation corresponding to the response action.

7. The system according to claim 6, wherein the response action comprises one or more actions of vibrating, tightening, heating and cooling, and the smart hand wearable device is further configured to make the one or more actions of vibrating, tightening, heating and cooling act on the finger corresponding to the identification information.

8. The system according to claim 6, wherein
the mobile terminal is further configured to inquire, by the virtual reality client, images of a plurality of preset gestures stored in a gesture database, and compare an image of the gesture of the finger with the images of the plurality of preset images, and determine whether a target preset gesture having a matching degree with the gesture of the finger is within a preset range exists in the plurality of preset gestures or not.

9. The system according to claim 8, wherein
the mobile terminal is further configured to, if a plurality of the target preset gestures exist, obtain a virtual picture viewed by the user when making the gesture of the finger; determine a virtual object pointed by the gesture of the finger in the virtual picture; and by combining a physical property of the virtual object and the gesture of the finger, determine the touch sensation demand information corresponding to the target preset gesture, and send the touch sensation demand information and the identification information of the finger to the smart hand wearable device.

10. The system according to claim 9, wherein
the mobile terminal is further configured to send a correspondence between the touch sensation demand information and the identification information corresponding to the gesture to the smart hand wearable device by means of a wireless propagation manner

11. A smart glove, comprising:
an information receiving apparatus and a response action generating apparatus;
the information receiving apparatus is configured to receive the touch sensation demand information and the identification information of the finger, which are sent by the virtual reality client; and
the response action generating apparatus is configured to convert the received touch sensation demand information into a response action, and make the response action act on the finger corresponding to the identification information such that the finger produces a touch sensation corresponding to the response action.
